(19) United States
(12) Patent Application Publication
(10) Pub. No.: US 2016/0321756 A1
(43) Pub. Date: Nov. 3, 2016

(54) METHOD AND SYSTEM FOR ESTIMATING THE COST OF CONSTRUCTING A HYDROCARBON FLUID PRODUCTION AND/OR PROCESSING FACILITY

(71) Applicant: SHELL OIL COMPANY, Houston, TX (US)

(72) Inventor: Jacobus Johannes Martinus VREEBURG, Rijswijk (NL)

(21) Appl. No.: 15/105,093

(22) PCT Filed: Dec. 15, 2014
(86) PCT No.: PCT/US2014/070331

§ 371 Date: Jun. 16, 2016

(30) Foreign Application Priority Data
Dec. 16, 2013 (EP) 13197320.8

(51) Int. Cl. G06Q 40/06; G06Q 50/08

(52) U.S. Cl. CPC G06Q 40/06; G06Q 50/08

(57) ABSTRACT

A Capital Cost Estimating Tool (CCET) and method for estimating the cost of constructing a hydrocarbon fluid production and/or processing facility comprise:
providing an engineering and procurement database that induces a user to identify aggregate quantities of components, other materials and associated transportation, installation and other labor, required to construct the facility and which database further comprises financial data with respect to the components, other materials and labor, including the cost for manufacturing or purchasing, transporting and installing the components and other materials in a specified currency and in money of the day, with provisions for associated financial uncertainty, including inflation, allowances, market factors, taxes and contingencies; and
providing a dashboard that presents to the user a cost estimate for constructing the hydrocarbon fluid processing facility based on the financial data derived from the engineering and procurement database and an associated financial uncertainty as a chance that the actual cost for constructing the facility will deviate from the presented cost estimate.

### BACKGROUND OF THE INVENTION

The invention relates to a method and system for estimating the cost of constructing a hydrocarbon fluid production and/or processing facility.

Complex construction and other capital cost estimation procedures are generally required to assess investments required for planned hydrocarbon fluid production and/or processing activities and to assess associated financial risks.

Aspentech offers an automated capital project estimating tool that reduces cost estimating uncertainties by using a model-based approach.

US patent application US2012/0271673 discloses a system and method for offering facility managers the ability to manage and track information, associated services and bids from vendors for capital projects relating to the facilities.

There is a need for further improvement of Capital Cost Estimating Tools (CCET) because increasing global energy demand accelerates the pace of change in the oil and gas industry. Regulatory rules and competitive landscapes are constantly in movement and new emerging technologies are pushing the boundaries of what is physically possible. Furthermore, the demand for mega-projects, both up- and downstream, is increasing rapidly. Achieving first quartile performance in this dynamic environment is demanding. Making the right decisions fast and accurate becomes evidently more important to retain a leading position in the industry. To achieve project excellence a strong alignment is required amongst businesses. As part of corporate strategy the up- and downstream project disciplines like planning and estimating have been merged.

Currently multiple estimating systems are used to create a single estimate. These systems are operating using different estimating methodologies. Some are quantity based and others are parametric. In addition, the type of detail differs between the various systems.

Thus there is a need for an improved Capital Cost Estimating Tool (CCET) and method that facilitates the merge of these different estimating systems into a single system using a single standardized approach and methodology.

### SUMMARY OF THE INVENTION

In accordance with the invention there is provided a method for estimating the cost of constructing a hydrocarbon fluid production and/or processing facility with various components, including pumps, vessels, on/offshore pipeline systems, process pipelines linking fluid processing facilities, support and foundation structures and power, control, safety and other equipment, and other materials, which components and other materials are manufactured or purchased at different locations and are subsequently transported to and assembled at a construction site of the facility, the method comprising:
providing an engineering and procurement database, which database induces a user to identify aggregate quantities of components, other materials and associated transportation, installation and other labor, required to construct the facility and which database further comprises financial data regarding the components, other materials and labor, which financial data include the estimated cost for manufacturing or purchasing, transporting and installing the components and other materials in a specified currency and in money of the day, with provisions for associated financial uncertainty, including inflation, allowances, market factors, taxes and contingencies; and
providing a dashboard that presents to the user:
   a) a cost estimate for constructing the hydrocarbon fluid processing facility based on the financial data derived from the engineering and procurement database; and
   b) the associated financial uncertainty as a chance that the actual cost, in money of the day, for constructing the facility will deviate from the presented cost estimate.

Optionally, the database is configured to calculate the aggregate cost of the components, materials and labor required to construct the facility in accordance with the following 14 steps:

1) estimate aggregate quantities of the components and equipment of the facility and of materials, labor and construction equipment required to construct the facility;
2) update each aggregate quantity using a quantity allowance for each of the aggregate quantities;
3) further update each aggregate quantity by providing a loss factor for each of the aggregate quantities;
4) estimate sourcing cost for each aggregate quantity, which sourcing cost estimate includes application of a sourcing profile and a productivity factor that depends on geographic location of the facility;
5) update the sourcing cost estimate using a location factor that depends on the geographic location of the facility;
6) further update the sourcing cost estimate updated in accordance with step (5) for each of the aggregate quantities using a sourcing cost allowance factor that depends on the geographic location of the facility;
7) further update the sourcing cost estimate updated in accordance with step (6) by estimating cost for transportation, tax and duties of each of components, materials and labor;
8) further update the sourcing cost estimate updated in accordance with step (7) using an estimated cost phasing factor associated with the moment on which the cost are expected to be made;
9) further update the sourcing cost estimate updated in accordance with step (8) using an estimated a market factor associated with the geographic location of the facility;
10) further update the sourcing cost estimate updated in accordance with step (9) using an estimated Engineering, Procurement & Construction tendering adjustment factor;
11) further update the sourcing cost estimate updated in accordance with step (10) using an estimated contingency factor;
12) further update the sourcing cost estimate updated in accordance with step (11) using an inflation correction factor that is associated with the moment on which the cost are expected to be made;
13) further update the sourcing cost estimate updated in accordance with step (12) by accumulating the sourcing cost estimates for all components, other materials and labor cost and expressing the accumulated sourcing cost estimate in a reporting currency; and
14) inducing the dashboard to present to the user the accumulated sourcing cost estimate as the cost estimate for constructing the facility updated in accordance with step (13) together with the associated financial uncertainty.

The associated financial uncertainty may be expressed as chance that the actual cost for constructing the plant will deviate from the cost estimate, which chance is adjustable from 1% to 99%, and may in a default setting of the dashboard be set at about 50%.

The hydrocarbon fluid production and/or processing facility may be an onshore or offshore crude oil and/or natural gas production facility, comprising crude oil and/or natural gas production wells and transportation pipelines, an oil refinery, a chemical plant in which hydrocarbon fluids are converted into marketable chemical products or a natural gas processing facility, such as a Gas To Liquids (GTL) production plant in which natural gas is converted into marketable liquid products or a Liquefied Natural Gas (LNG) processing facility.

Furthermore, the hydrocarbon fluid production and/or processing facility may comprise a series of standard scalable components, such as pumps, vessels, pipelines, columns, columns, support structures and power supply, safety and control systems of which the designs and cost estimates are stored in the database and the engineering and procurement database may comprise a scope tree with a Work Breakdown Schedule (WBS) that groups the hydrocarbon fluid processing facility into the groups of onshore, offshore and deepwater hydrocarbon fluid processing facilities and associated wells, pipelines and terminals and which groups the components into e.g.; hardware items, system groups, equipment accessories, derived items, etc. The database may comprise a user interface which allows a user to generate a design of the hydrocarbon fluid production and/or processing facility by selecting in the database components which the user identifies to be suitable for a given flux, composition, pressure and/or other physical characteristics of the hydrocarbon fluid to be processed in the facility.

Optionally the hydrocarbon fluid production and/or processing facility is constructed if the cost estimate does not exceed a selected limit.

This limit may be determined by envisaged economic benefits from exploitation of the processing facility.

In accordance with the invention there is furthermore provided a system for performing the method according to the invention, which the system comprises a computer readable medium, which when connected to a computer, causes the computer to execute the method according to the invention.

These and other features, embodiments and advantages of the method and/or system according to the invention are described in the accompanying claims, abstract and the following detailed description of non-limiting embodiments depicted in the accompanying drawings, in which description reference signs are used which refer to corresponding reference signs that are depicted in the drawings.

Similar reference signs in different figures denote the same or similar objects. It is observed that any numerical values given in the following calculations, tables and drawings are hypothetical and are subject to fluctuations over time, so that the numerical values and associated calculations and results shown in the examples are only illustrative and should not be assumed to reflect actual values.

### BRIEF DESCRIPTION OF THE DRAWINGS

FIG. 1 shows the CCET data flow from project scope to cost;

FIG. 2 shows CCET engineering and configuration models;

FIG. 3 shows the CCET Work Breakdown Schedule (WBS);

FIG. 4 shows the CCET Scope Tree;

FIG. 5 shows 14 steps of CCET to estimate cost of mechanical labor required to build a hydrocarbon processing facility; and

FIG. 6 shows 14 steps of CCET to estimate cost steel required to build a hydrocarbon processing facility.

### DETAILED DESCRIPTION OF THE DEPICTED EMBODIMENTS

Achieving first quartile performance in the current oil and gas industrial environment is challenging. The ability to make the right decision fast and accurate in the early phases of a project becomes evidently more important. The Capital Cost Estimating Tool (CCET) according to the present invention is capable of providing project estimates even when minimal information is known. By means of mathematical models describing engineering scope, quantities are calculated. A framework for cost calculations provides an end-to-end approach to estimate project cost.

The CCET according to the invention provides the following benefits:
Cost consistency throughout the project funnel
Better ranking of project portfolio
Improvement in cost estimating performance
Higher productivity in estimate generation
Better benchmarking capabilities

Cost estimating is the calculated approximation of cost which is usable even if input data may be incomplete or uncertain. Estimating in a construction engineering context describes the process of forecasting the total cost of the engineering project taking into account various factors amongst:
Scope uncertainties
Location influences
World market conditions
Project schedule
Project management.

The estimated cost can encourage investment in the project if the cost is economically acceptable. Since a decision to invest is not an instance based decision, several iterations are required in which both scope and estimated cost are further refined. The process of maturing business opportunities from initial idea to value realisation is shaped in an over-arching framework. The framework divides the realisation of a business opportunity into logical phases. A decision gate punctuates each phase and decisions drive all activities and deliverables.

Table 1 provides an overview of four phases of project development currently identified. The accuracy of the project cost estimate increases with each subsequent phase as scope definition improves and assumptions are reduced. The estimate type indicator shows implicitly the maturity of the project in terms of scope definitions and the quality of engineering data available.

TABLE 1
Overview of project phases and estimate types

| Phase | Description | Type | Prepared |
|---|---|---|---|
| Identify | Identify an opportunity | 0 | End of identify phase |
| Asses | Asses feasibility | 1 | End of asses phase |
| Select | Select a concept | 2 | End of select phase |
| Define | Define a design | 3 | End of define phase |
| Execute | Execute the project | 4 | During execute phase |

Typically an estimate will progress from a Type 0 to a Type 4 estimate as alternatives are discarded and more information becomes available.

The CCET system and method according to the invention are currently capable of providing Type 0-Type 3 estimates whereas Type 4 is still under development.

The CCET system according to the invention, also abbreviated as CCET is a quantity based estimating system.

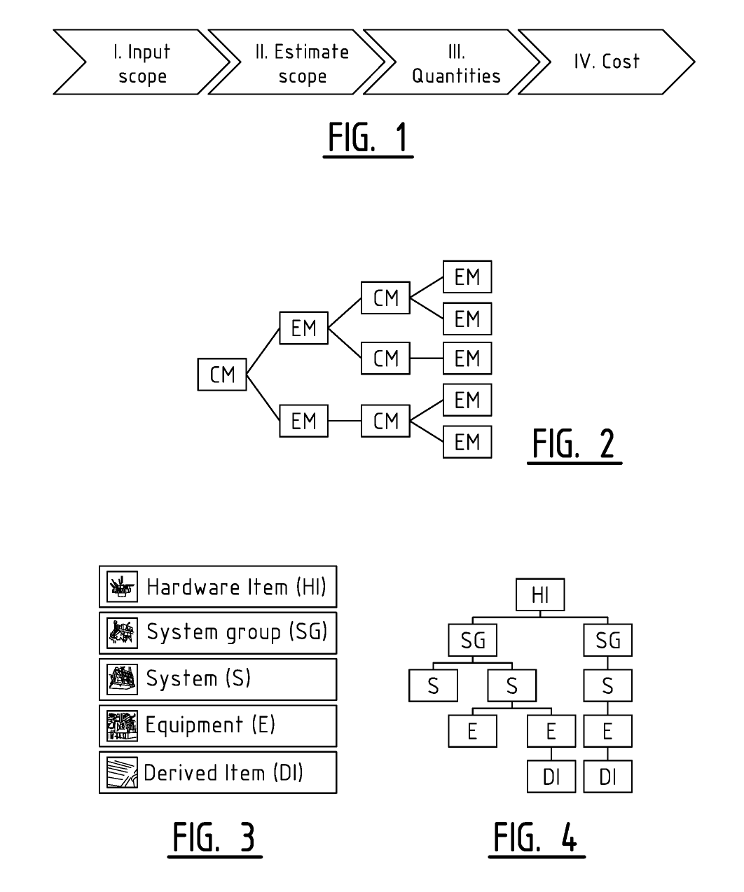

By means of scope input quantities are calculated which are priced to generate estimate cost. The high level process from scope to cost in CCET is depicted in FIG. 1. The approach to calculate estimated cost is identical for every Type 0-3 assuring consistency of the estimate over the various phases. The CCET system according to the invention works on the basis that early in the project design not all scope components are known in detail. The CCET system according to the invention solves this by generating a complete detailed scope by means of mathematical models pre-set with best-practice default values. Estimated cost only changes when new scope information becomes available and scope is added or changed and initial pre-set default values are replaced with actual values. Changing the estimate Type has no effect on estimated cost because the flow of calculations and the mathematic models in place remain identical.

In the following paragraphs four subsequent steps I-IV to come from input scope to cost are described.

I. Input Scope

Creating an estimate in CCET starts with the definition of the project. This includes locations of construct (sourcing), project environment or any special conditions applicable. Secondly scope input is required. Since CCET is designed to be the single source of estimates for capital expenditure it covers the full range of scope required in the oil and gas industry. At the highest level the following scope is covered in CCET:
Process facilities on- and offshore
Pipelines
Wells
Substructures floating and fixed
Deepwater
Terminals

These scope items are further differentiated in smaller scope items and are eventually providing the differentiation in scope and cost elements required for Type 3 estimates.

II. Estimate Scope

CCET facilitates the generation of a complete detailed scope by means of mathematical models logically connecting scope items, making it easier and faster for the user to create an estimate In general there are two distinct types of models in CCET:
Cost engineering models (EM)
A set of algorithms that describe the mapping of input variables to output variables of a specific piece of scope. Some output variables are quantities.
Configuration models (CM)
A configuration model describes relations between engineering models.

FIG. 2 illustrates the connection between cost engineering and configuration models which together form the model landscape of CCET covering all types of scope required in the oil and gas industry.

To logically constrain the ordering of scope in CCET a Work Breakdown Structure (WBS) has been brought into place.

The levels of the WBS are shown in FIG. 3.

The top level in the WBS shown in FIG. 3 is the hardware item level (HI). As an example, the hardware item level represents an entire offshore production facility with the following underlying scope breakdown:
SG: gas separation
S: gas compression
E: compressors
DI: structural steel

The WBS is a logical hierarchy of scope in an oil and gas engineering project and acts as a backbone on the model landscape. By means of configuration models the CCET system constructs a scope tree out of cost engineering models thereby defining pieces of the project scope. FIG. 4 shows the hierarchical CCET scope tree which is defined by means of connected engineering models over the WBS structure. At any level the user is allowed to influence the scope making CCET very flexible.

III. Quantities

At any level in the WBS structure, cost engineering models are calculating quantities for a base project location. In CCET a quantity is used to refer to any type of quantitative properties of a cost element. Some examples on quantity items:
Man-hours electrical labor
Weight stainless steel pipe 8 inch (˜20 cm diameter)

A quantity item has a Unit of Measurement in which the quantity is expressed. The specifications of the quantity are called qualifiers and are important for price determination. Within CCET every quantity is connected to the CCET Cost Breakdown Structure (CBS) which provides adequate detailing for Type 3 estimating. By means of the CBS coding system quantity allowances and adjustments are applied on the quantities in a flexible and standardized approach. Both the allowances and adjustment factors are depending on location settings of the project defined during estimate creation.

A major benefit of quantity based estimating is that the calculated quantities provide a transparent basis for benchmarking versus internal/external KPI's of estimated project scope. Estimated quantities are used in comparison with contractor proposals, schedules, risk profiles and cost control (management).

IV. Cost

The quantity amount and governing qualifiers determine the cost of the quantity by means of a unit rate. The unit rate is the price for a certain amount of the quantity and qualifier combinations. This price is valid in a base reference location, expressed for an applicable currency and date. Multiplication of all quantities and their governing unit rates results in identified cost at standard location expressed in a single currency. Hereafter by means of the CBS; identical to the quantity allowances; cost allowances are applied.

Location settings are used to change perspective from standard location to the locations of construction and implementation. Depending on the execution strategy of the project this results in a multi-currency estimate.

The unit rates in CCET are kept up-to-date by means of an indexation and feedback strategy taking into account volatile components of nowadays market. Indexation models are utilised to enable incorporations of direct market intelligence (normalised cost data for bulk materials, commodities and construction equipment) and/or more generic cost indexes.

All location settings in CCET are captured in a tabular format providing transformation of quantities and cost from standard location to project locations. This table is created on estimate initiation and is pre-filled with default values applicable for the selected countries and regions. When required, the estimator is able to overwrite these default values with project related values. Amongst the location settings are:
Source of equipment and bulk materials split by region or country
Duties and handling charges, transport insurance and freight
Labor/staff rates (direct and indirect) based on crew compositions
Indirect cost ratios (supervision, profits, erection equipment, sundries, local expenses, temporarily facilities, scaffolding)
Labor/staff productivities
Location cost factor (generic cost ratio's)

By means of location surveys and benchmarking the default location settings are kept up-to-date.

To effectively capture and re-use the knowledge and quality put into place by the estimator when creating an estimate, CCET uses the concept of library items. A library item is effectively a hardware item, system group or a system, which has re-usable and assured scope. A library item is kept in a separate repository and can be used by the estimator as a quick start instead of starting from scratch. The user can modify the scope of the library item as required by overwriting scope values and by applying scaling rules. The decision of constructing an estimate from scratch or using library items is entirely up to the CCET user. CCET is designed as an end-to-end system meaning all calculation routines and options to create a capital cost estimate are included, amongst:
Market Factor integration
Incorporating the flexibility to cover future market movements.
Contingencies
Covering cost for changes as a result of further definition and variations emerging in the subsequent phases. Contingency values are determined by a risk module fully integrated in CCET.
Inflation and Phasing
Uplifting the estimated cost by taking into account Rate of Exchange variations of currencies of spend and local country inflation rates in the phasing of cost.
Purchase Orders
Application of PO orders for either individual scope items or bulk materials.
Overwrites
A significant number of outputs calculated by the engineering models or intermediate cost results can be overwritten allowing the user full control of the calculated quantities and cost.
Scaling
Scaling is a general term for re-defining an already completed scope by changing one or more of the key properties. An example of scaling may be the changing of the throughput of a particular process configuration
Import features
Various import features for data exchange purposes like equipment and process parameters and upload of base financial information like exchange rates, inflation numbers and market factors.

CCET being an end-to-end system minimizes the need for additional compilations and assures quality, consistency of the estimate.

CCET is facilitating the maturing and detailing of a project. The approach to calculate estimated cost is identical for every project phase assuring consistency of the estimate over the various phases. CCET works on the basis that early in the project design phase not all scope components are known in detail. CCET facilitates the generation of a complete scope by means of mathematical models, calculating all required scope quantities. Costs are calculated by means of applying unit rates. Location settings allow estimation of projects all over the globe.

Being and end-to-end system CCET provides the ability to adequately respond to today's project and economical environment.

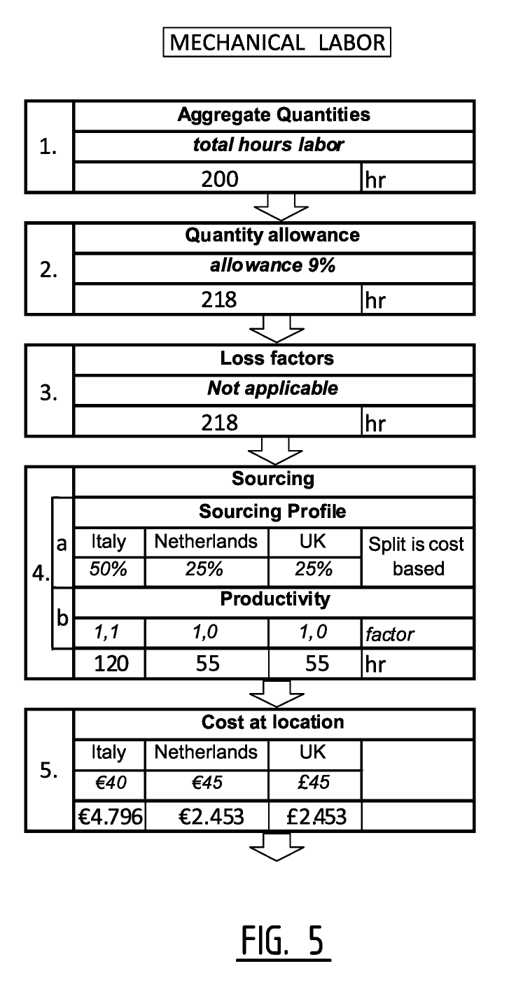

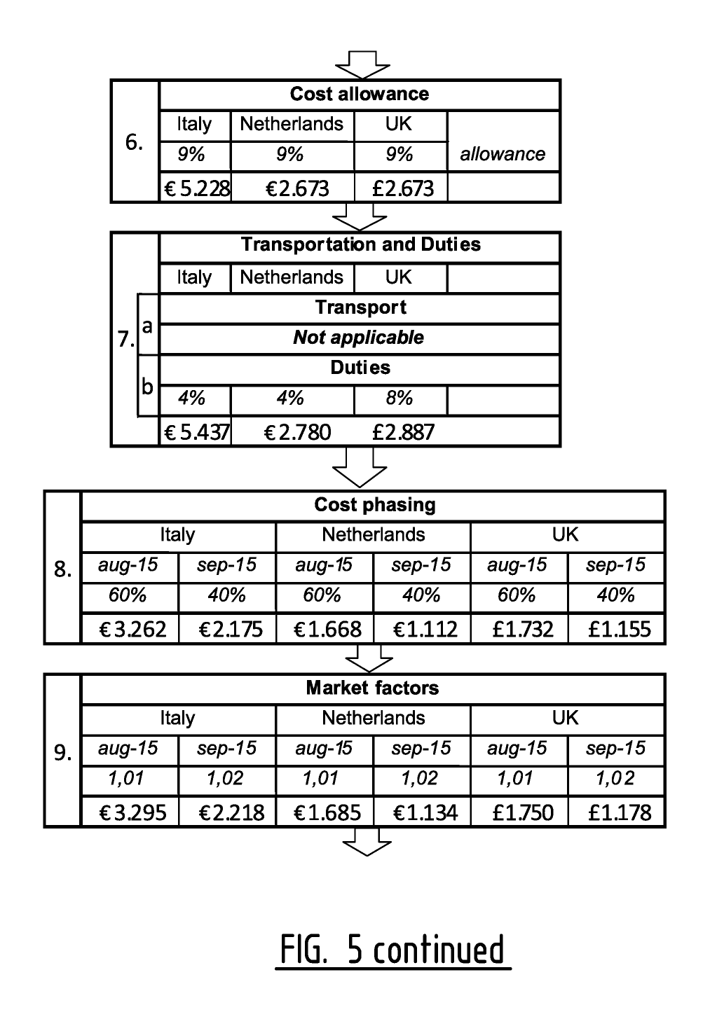

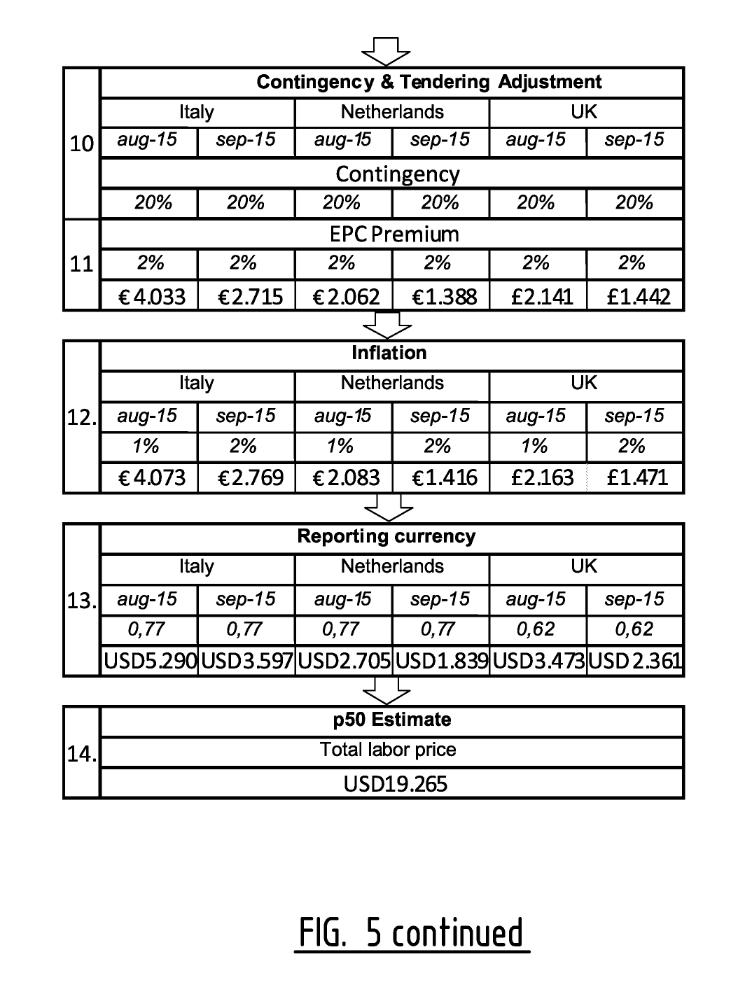

FIG. 5 shows the 14 steps of CCET to estimate cost of mechanical labor required to build a hydrocarbon processing facility.

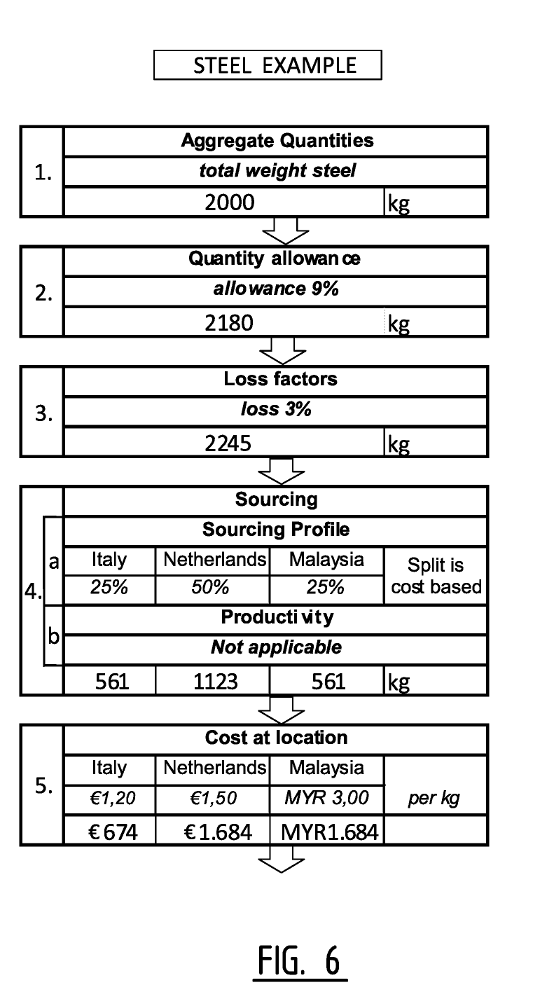

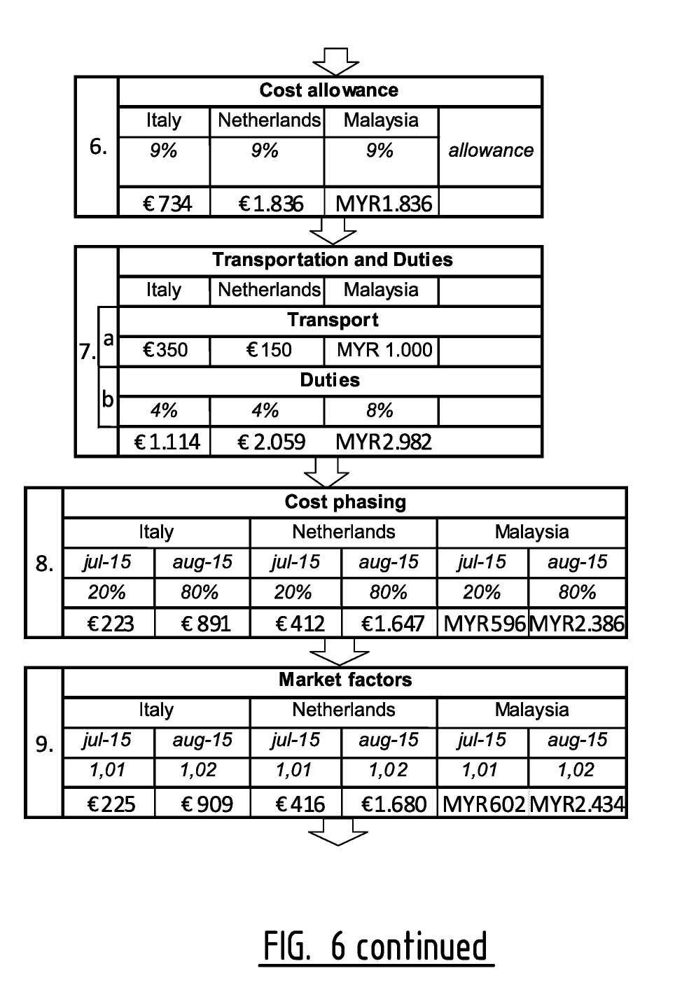

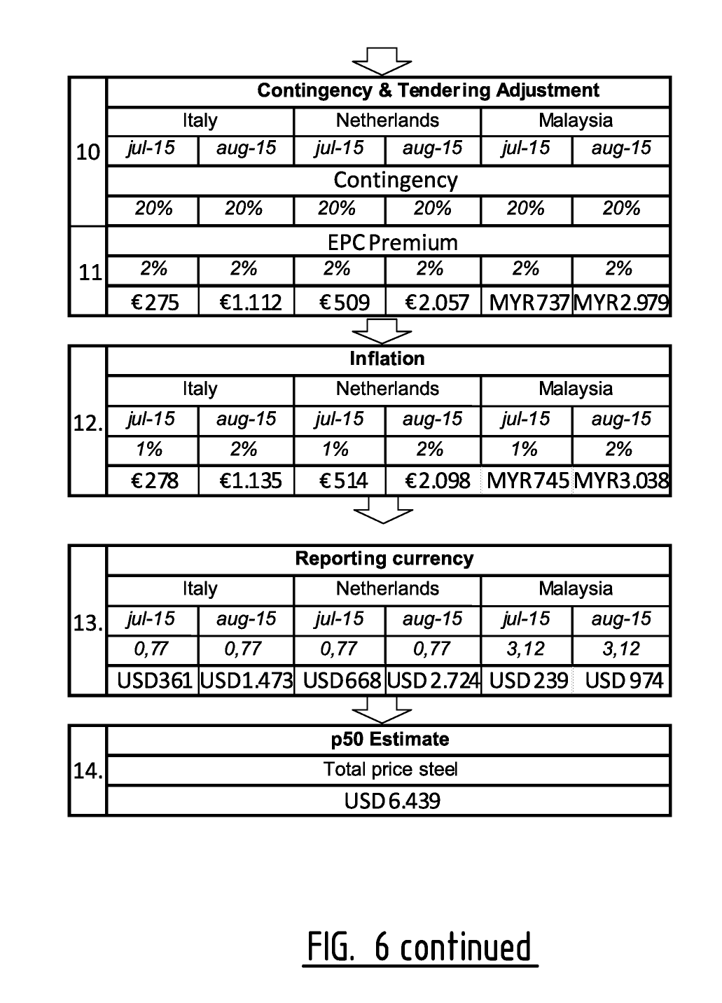

FIG. 6 shows the 14 steps of CCET to estimate cost of mechanical labor required to build a hydrocarbon processing facility.

Details of the 14 steps of CCET shown in FIG. 6 are described in more detail below.

Step 1: Aggregate Quantities

In step 1 of CCET all quantity information is gathered and aggregated.

Table 2 gives all necessary input for this step.

TABLE 2
Input step 1
Quantities

Quantity amount
Quantity UOM
Description/CBS (NORSOK) label
Primary Qualifier
Qualifiers

All quantities are aggregated on CBS (NORSOK) code level. The quantities are based on these CBS (NORSOK) codes, divided in CBS (NORSOK) groups. Only similar CBS (NORSOK) codes can be added up to a single quantity; like mechanical labor (50 hours+100 hours+10 hours).

Labor related quantity contains an additional calculation; each quantity is multiplied with a location productivity factor. This factor accounts for the difference in productivity between various parts of the world. For example, when certain labor takes place at locations with high temperatures, productivity will be less than for locations with lower temperatures. Assume that the construction location is the Netherlands, and that there are 500 hrs of Mechanical direct labor.

TABLE 3A
Productivity rates Mechanical direct labor

| Extended | | Primary | | | Europe | | | | | | | |
|---|---|---|---|---|---|---|---|---|---|---|---|---|
| NORSOK | Description | Qualifier | Qualifiers | Europe | Belgium | Cyprus | France | Germany | Greece | Italy | Malta | Netherlands |
| LR_{—} | Mechanical | | | 1.05 | 1.05 | 1.0 | 1.05 | 1.0 | 1.0 | 1.0 | 1.0 | 1.05 |
| | Direct Labour | | | | | | | | | | | |

| Extended | Europe | | | Asia Pacific | | | | | | | | | . . . |
|---|---|---|---|---|---|---|---|---|---|---|---|---|---|
| NORSOK | Switzerlands | UK | Asia Pacific | Japan | Korea | Laos | Malaysia | Myanmar | Nepal | Phillipines | Singapore | Thailand | . . . |
| LR_{—} | 1.05 | 1.05 | 0.95 | 1.0 | 1.0 | 0.95 | 0.95 | 0.95 | 0.95 | 0.95 | 0.95 | 0.9 | . . . |

Assuming the productivity rates provided by Table 3A are correct, the calculation for the Netherlands will be as follows: 500 hrs*1.05=525 hrs

Calculations for non-labor related quantities, will not be multiplied with a productivity factor (or this factor is always equal to 1).

Columns and piping, while having a different unit rate will have to be listed separately. After step 5 (where quantities are multiplied with their unit rate) all costs can be aggregated per CBS group.

Table 3B gives an example of the level on which quantities can be aggregated for columns. In this example Carbon steel columns have a different unit rate (cost curve) than Stainless steel and Alloy columns. Therefore these groups cannot be aggregated, before step 5, where the quantities are translated to costs.

TABLE 3B
Example Column

| Extended | | Primary | | | |
|---|---|---|---|---|---|
| NORSOK | Description | Qualifier | Qualifier | Quantity | UOM |
| E_{—} | Equipment | | | | |
| ER_{—} | Miscellaneous | | | | |
| | Mechanical | | | | |
| | Equipment | | | | |
| ERV_{—} | Vessels and | | | | |
| | Columns - | | | | |
| | Pressurized | | | | |
| ERVEA | Columns | | | | |
| ERVEAA | Columns (note: | | | | |
| | Incl internals) | | | | |
| ERVEAAA | C.S. Columns | 3000 kg | | 3 | no |
| ERVEAAB | S.S. and Alloys | 5000 kg | | 1 | no |
| | Column | | | | |

Different kinds of mechanical labor hours can be aggregated.

Table 3C gives an example of this. Because the cost per hour for Centrifugal Pump Services equals the cost per hour for Compressor Services, these quantities can be added immediately.

TABLE 3C
Example Mechanical labor

| | | Primary | | | |
|---|---|---|---|---|---|
| Extended | Description | Qualifier | Qualifier | Quantit | UOM |
| LR_{—} | Mechanical Direct | | | 1000 | hr |
| | Airco/Heating | | | | |
| | Services | | | | |
| | Centrifug. Pump | | | | |
| | Compressor | | | | |
| | Services | | | | |

After all quantities are aggregated, the user has the option to change the value of the quantities, or the value of the primary qualifier, when this is defined for a certain quantity. This leads to the final quantities and primary qualifiers, which will be used in step 2.

Step 2: Quantity allowances

In step 2 quantity allowances are added to each quantity or primary qualifier. Necessary input for this step is given by Table 3D.

TABLE 3D
Input step 2

| Estimate Type | Type 1 | Type 2 | Type 3 |
|---|---|---|---|
| Project Execution Strategy | Greenfield | Brownfield | |
| Implementation Method | Stick build | Modular | |

As indicated before, there are three categories I-III of quantity allowances:
I) Base Quantity Allowance: a factor used for indicating the difference between the
   Base Quantities that results from step 1 (Aggregated Quantities) and the quantity including:
      MTO Allowance: this covers materials that are usually not shown on drawings or specifically defined at the time the estimate is prepared. Examples are minor utility piping, steel gusset plates, etc.
      Development Design Allowance: this covers equipment adjustments that occur through the normal evolution of engineering, i.e. from initial diagrams, layouts and specifications to final design. Examples are changes to design details, nozzles and manholes, locations, clips, etc.
      These allowances depend on the estimate type. A type 1 estimate will receive a higher quantity allowance than a type 2 estimate.
II) Implementation method quantity allowance: a factor used for adding additional quantities in case the implementation method is Modular. This reflects the fact that the CEM's do not incorporate this. This allowance therefore depends on whether the implementation method is stick build or modular.
III) Project execution strategy quantity allowance: a factor used for adding quantities in case the project execution strategy calls for this. Also, this reflects the fact that the CEM's do not incorporate this. The allowances depends on the whether the project execution strategy is greenfield or brownfield.

These last two allowances are added because both implementation method and project execution strategy might have an impact on: integrity of existing facilities/utilities, life cycle cost for existing main equipment, reuse of existing equipment and materials, correctness of existing drawings, disruption of operating units, timing/scheduling consequences, Risks, HSSE, etc.

Further Calculations of Step 2:

Each of the three allowances is added to the quantity or primary qualifier. Table 3E gives an example of quantity allowances which may be used for Carbon Steel Columns

TABLE 3E
Quantity allowances column

| | | | | | | | 2. Implementation | | Execution Strategy | |
|---|---|---|---|---|---|---|---|---|---|---|
| | | | | 1. Base Quantity | | | Method Quantity | | 3. Project | |
| | | | | Allowance | | | Allowance | | Quantity Allowance | |
| | | | | Project Data: | | | Project Data: | | Project Data: | |
| Reference parameter | | | | Estimate Type | | | Implementation Method | | Execution Strategy | |
| Extended NORSOK | Description | Primary Qualifier | Qualifiers | Type 1 | Type 2 | Type 3 | Stick Build | Modular | Greenfield | Brownfield |
| ERVEAAA | C.S. Columns | 3000 kg | | X % | Y % | Z % | A % | B % | C % | D % |
| . . . | . . . | . . . | | . . . | . . . | . . . | . . . | . . . | . . . | . . . |

The group Carbon steel has a primary qualifier of 3000 kg. Quantity allowances will therefore be added to the primary qualifier instead of the quantity. If the user has indicated that the Estimate type is type 1, the implementation method is stick build and the project execution strategy is greenfield, the quantity including quantity allowance will be calculated as follows: 3.000 kg*(10X %)*(10Y %)*(10Z %)=3.000 kg*10Q %=3.XYZ kg.

For step 2 equals the cost calculation for non-labor related quantities to the labor related quantities.

Step 3: Loss Factors

In step 3 quantities are adjusted based on construction location depended loss. Input for step 3 is given by:

Input step 3
Construction location

The construction location dependent loss is designed to translate installed (or nett) quantities to purchased (gross) quantities. Construction dependent loss includes weather downtime, theft, etc. For some bulk materials an extra allowance is added: cut and waste allowance. Further calculations of step 3 are described below.

TABLE 3F
Cut and waste allowance & loss factors pipework

| | | | | Cut & | | | | | | | | |
|---|---|---|---|---|---|---|---|---|---|---|---|---|
| Extended | | Primary | | Waste | | Europe | | | | | | |
| NORSOK | Description | Qualifier | Qualifiers | Allowance | Europe | Austria | Belgium | Cyprus | Denmark | Finland | France | Germany |
| BLA_{—} | Pipework | | | 2% | 1% | 1% | 1% | 1% | 1% | 1% | 1% | 1% |

| Extended | Europe | | | | | | | | | | | | . . . |
|---|---|---|---|---|---|---|---|---|---|---|---|---|---|
| NORSOK | Gibraltar | Greece | Italy | Malta | Netherlands | Norway | Poland | Portugal | Spain | Sweeden | Switzerland | UK | . . . |
| BLA_{—} | 1% | 1% | 1% | 1% | 1% | 1% | 1% | 1% | 1% | 1% | 1% | 1% | . . . |

Table 3F gives an example of cut & waste allowances and loss factors which may be used for pipework. Assume that the amount of pipework equals 2000 kg. If the user has indicated that the construction location is the Netherlands, the calculations for step 3 will look as follows: 2000 kg*(102%)*(101%)=2000 kg*105%=2101 kg.

For quantities which do not require cut and waste allowance, the cut & waste allowance will be 0%. Step 3 is not necessary for labor related quantities. All percentages can be set to 0% for these quantities.

Step 4: Sourcing Profile and Productivity

For every construction location there is a default sourcing profile. This profile assigns which percentage of cost of each quantity. The sourcing location is the location where certain quantities are purchased, or where certain labor takes place, in case of labor related quantities. Input for step 4a (Sourcing) is given in Table 3G.

TABLE 3G
Input step 4

Construction location
EFA Applicable

As stated before for Enterprise Framework Agreements (EFA) there will be a separate profile. If EFA Applicable has the value ‘yes’ for a certain Hardware Item Group, the EFA sourcing profile will be used instead of the construction location sourcing profile, for all quantities part of this Hardware Item.

Because step 4 divides quantities per location, all further calculation will have to be done per location.

Step 5: Cost at Location

In step 5 all quantities are translated to cost. For all CBS group cost curves are defined, which map the unit rate (cost/uom quantity) against the uom of the quantity. As stated before, each quantity has a base cost curve (unit rate), dated on the EDM date: 1 Jul. 2011. This cost curve is related to a base location. Per quantity is for each sourcing location a cost at location factor defined, to translate the base cost curve to the sourcing location cost curve. Because cost curves are given in the local currency, exchange rates are necessary to set the curves to the correct currency. Input for step 5 is given by:

Input step 5
Sourcing locations

At the end of step 5 is each quantity per sourcing location is multiplied with its cost rate, resulting in cost per quantity per location.

Further calculations of step 5 are described below.

Table 3H gives all information gathered from previous steps, necessary for step 5. There are 3 columns, with an adjusted weight of 3.309 kg. The sourcing profile states that 25% of column cost is related to Italy, 50% to the Netherlands and the last 25% to Malaysia.

TABLE 3H
Example Columns

| | Primary Qualifier (after | |
|---|---|---|
| Quantity | step 3) | Sourcing profile |
| 3 | 3.309 kg | Italy X %, Netherlands Y %, |
| | | Malaysia Z % |

In step 4 it is determined that the total weight of columns is divided over the sourcing locations.

Table 3I gives these results for the example.

TABLE 3I
Quantities Columns per sourcing location

| Italy | The Netherlands | Malaysia |
|---|---|---|
| 3 * X % * 3.309 kg = | 3 * Y % * 3.309 kg = | 3 * Z % * 3.309 kg = |
| A kg = .00A mT | B kg = .00B mT | C kg = .00C mT |

These are not the weights that should be used to determine cost per kg for columns, because this is not the actual weight of the column. This weight is given by the value of the primary qualifier after step 3 (i.e. 3309 kg).

Assume that the base location for columns is Italy. The base cost curve for columns in Euro/mT is given by the following formula:

y=56,913x²−1104,7x+6457,1

Table 3J gives all further information necessary to determine cost curves for the Netherlands and Malaysia, and to give a view of these in both local currency and USD dollar.

TABLE 3J

| | Exchange rate | Cost at | |
|---|---|---|---|
| COLUMNS | to USD (1-7- | location | |
| SOURCES | 2011) | factor | Cost curve USD |
| Italy | 1.44882 | X | y = 82.457x² − 1600.5x + a |
| Netherlands | 1.44882 | Y | y = 90.702 x² − 1760.5x + b |
| Malaysia | 0.33035 | Z | y = 32.983x² − 640.19x + c |

To determine the cost per location the following calculations are necessary:

Cost/mT Italy=56,913*(3.309/1.000)²−1104,7*(3.309/1.000)+d=e euro/mT

Cost/mT Netherlands=62,604*(3.309/1.000)²−1215,1*(3.309/1.000)+f=g euro/mT

Cost/mT Malaysia=99,841(3.390/1.000)²−1937,9*(3.309/1.000)+h=j MYR/mT

Total cost Italy=2,482 mT*e euro/mT=k euro

Total cost Netherlands=4,964 mT*g euro/mT=l euro

Total cost Malaysia=2,482 mT*j MYR/mT=m MYR

Because the primary qualifier has UOM kilogram, and the cost is given in metric tonnes, the value 3.309 needs to be divided by 1.000.

The cost of a column depends on the weight of a column. As indicated earlier, the cost/UOM quantity for several other quantities depend on the value of the quantity (or primary qualifier).

But there are also quantities where the cost/UOM quantity may be independent of the value of the quantity, for example, mechanical labor. For generality these cost are also given by a curve, but this has a constant value. For example, if at location the Netherlands 450 hours of mechanical labor takes place, and the cost of this labor is given by 55 euro/hr, the cost calculation will be straightforward:

450 hr*55 euro/hr=24.750 euro.

Step 6: Cost Allowances

As noted before, is step 6, cost allowances, similar to step 2, quantity allowances. Both steps require the same input as illustrated in table 3K.

TABLE 3K
Input step 6

| Estimate Type | Type 1 | Type 2 | Type 3 |
|---|---|---|---|
| Project Execution Strategy | Greenfield | Brownfield | |
| Implementation Method | Stick build | Modular | |

The cost allowances are also divided in three categories:
IV) Base cost allowances: this factor indicates that the cost in reality will differ from the calculated cost.
V) Implementation method cost allowances: this factor adds cost in case the implementation method is Modular. This reflects the fact that the CEM's do not incorporate this.
VI) Project execution strategy cost allowances: this factor adds cost in case the project execution strategy calls for this. This reflects the fact that the CEM's do not incorporate this.

The calculations in this step are also similar to the calculations in step 2. An example of these calculations can, therefore, be found in section ‘Further Calculations of step 2’.

Step 7: Transportation and Duties

Each CBS Group that needs to be transported from its sourcing location to the construction location receives additional transportation costs. These costs depend on the weight of the quantity and on the distance between the sourcing location and the construction location. Necessary input for step 6 can be found in table 3L.

TABLE 3L
Input step 6

Construction location
Sourcing Profile
Weight quantity

A transportation cost curve is determined based on historical project data, and is given in USD at the EDM date. As mentioned earlier, a distance table is necessary to determine the distance between sourcing and construction location. After calculating the transportation costs, these are converted from USD to the local currency of the sourcing location.

Since labor takes place at the sourcing location, no additional transportation costs are calculated, for labor related quantities.

Duties apply to both labor and non-labor related quantities. For each quantity, an additional percentage is added to the costs.

Further calculations for step 7 are described below.

Continuing the example of the previous section, transportation costs for columns from Malaysia will be calculated. The distance table indicates that Malaysia lies approximately 15.000 km from the Netherlands.

The amount of columns transported from here is 2,482 mT (see Table 3I). Transportation costs are:

−0.65 ln(15.000)+6,5=0,25 USD/km/mT

This brings the total transportation cost on

0.25 USD/km/mT*15.000 km*2,482 mT=9.308 USD=28.175 MYR

Duties apply to the costs which are the result of step 6.

Assume that the columns which are procured in Malaysia cost 160.400 MYR after step 6, and that duties are 5% if columns are brought from Malaysia to the Netherlands.

Total cost including duties will then become:

160.400 MYR*105%=170.220 MYR.

Total cost after step 7 will be:

28.175 MYR+170.220 MYR=198.404 MYR.

Step 8: Cost Phasing

Step 9 phases the cost per sourcing locations over the years by means of a phasing profile (S-Curve). This profile specifies how much of the cost will be incurred between the start date and end date of the activity. Each hardware item will be using the same S-curve. Generally there are different S-curves for Engineering, Procurement and Construction. The user can indicate the phasing profile that should be used. If the user does not indicate this, the default phasing profile will be used. Necessary input for this step is given by Table 3M.

TABLE 3M
Input step 8

Start EPC
RFSU
Phasing profile

Further calculations for step 8 are described below.

Let a phasing profile be selected by the user. Three S-curves given in percentages may be listed; one for procurement, one for construction and one for engineering. Table 3N indicates that Start EPC is in March 2014, and ends in July 2015.

TABLE 3N
Example phasing profile

| | Phasing | | | | | | | | | | | | | | | | |
|---|---|---|---|---|---|---|---|---|---|---|---|---|---|---|---|---|---|
| | mrt- | apr- | | | | | | | | | | | | | | | |
| | 14 | 14 | mei- | jun- | jul-14 | aug-14 | sep- | okt-14 | nov-14 | dec- | jan-15 | feb- | mrt-15 | apr-15 | mei- | jun- | jul-15 |
| Procurement | | | | | 8% | 18% | 25% | 25% | 18% | 8% | | | | | | | |
| Construction | | | | | | | | 7% | 9% | 10% | 12% | 14% | 13% | 12% | 10% | 9% | 7% |
| Engineering | 9% | 15% | 17% | 20% | 17% | 15% | 9% | | | | | | | | | | |

Table 3O then gives an example of the monthly payments for columns, mechanical direct labor and engineering manpower.

FIG. 3O: Example cost phasing

| | | Netherlands | | | | | | | | |
|---|---|---|---|---|---|---|---|---|---|---|
| CBS Group | | mrt-14 | apr-14 | mei-14 | jun-14 | jul-14 | aug-14 | sep-14 | okt-14 | nov-14 |
| Columns | [symbol] 36.341 | | | | | [symbol] 2.726 | [symbol] 6.360 | [symbol] 9.085 | [symbol] 9.085 | [symbol] 6.360 |
| Mechanical Direct Labour | [symbol] 43.357 | | | | | | | | [symbol] 2.818 | [symbol] 3.902 |
| Engineering Manpower | [symbol] 36.462 | [symbol] 3.099 | [symbol] 5.469 | [symbol] 6.016 | [symbol] 7.292 | [symbol] 6.016 | [symbol] 5.469 | [symbol] 3.099 | | |

| | Netherlands | | | | | | | | |
|---|---|---|---|---|---|---|---|---|---|
| CBS Group | dec-14 | jan-15 | feb-15 | mrt-15 | apr-15 | mei-15 | jun-15 | jul-15 | aug-15 |
| Columns | [symbol] 2.726 | | | | | | | | |
| Mechanical Direct Labour | [symbol] 4.336 | [symbol] 4.986 | [symbol] 5.853 | [symbol] 5.420 | [symbol] 4.986 | [symbol] 4.336 | [symbol] 3.902 | [symbol] 2.818 | [symbol] 2.818 |
| Engineering Manpower | | | | | | | | | |

After step 8 costs will be divided per location, and for each location they will be divided per monthly period.

Step 9: Market Outlook

Market escalation is the increase in costs in real terms (i.e. cost increase over and above inflation). This escalation is for the specific purpose of producing estimates for economic analysis, business planning and portfolio analyses and reflect the expected market movements within the oil and gas capital project industry. The market outlook document is published annually and is based on Shell scenarios. The current scenarios are referred to as SV (Screening Value), RV (Ranking Value) and HV (High Value).

All costs need to be escalated from the EDM date (Jan. 7, 2011) to period the amount is spend.

Steps 10 & 11: Contingency and Tendering Adjustment

With TECOP (Technical, Economic, Commercial, Organisational, (Socio-)Political) Deterministic Risk Analysis the contingency of a project is determined. Because the calculations of the tendering adjustment require similar inputs, these steps will be combined. Input will either be determined in previous steps; or added by the user. For example the construction location, project execution strategy, and tendering adjustment period could provide input for several topics of the TECOP and tendering adjustment table.

Step 12: Inflation

In step 12 inflation is taken into account. The inflation depends on the sourcing location and the phasing profile.

Input step 12

Sourcing locations
Phasing profile

For each location inflation is given per year with respect to the EDM date.

1) Calculations Step 12

Assume that Table 3P gives the cost of mechanical labor at the location the Netherlands over the period October 2014 to August 2015.

TABLE 3P

| | Netherlands | | | | | | | | | | |
|---|---|---|---|---|---|---|---|---|---|---|---|
| CBS Group | okt-14 | nov-14 | dec-14 | jan-15 | feb-15 | mrt-15 | apr-15 | mei-15 | jun-15 | jul-15 | aug-15 |
| Mechanical | [symbol] 3.382 | [symbol] 4.683 | [symbol] 5.203 | [symbol] 5.983 | [symbol] 7.024 | [symbol] 6.504 | [symbol] 5.983 | [symbol] 5.203 | [symbol] 4.683 | [symbol] 3.382 | [symbol] 3.382 |
| Direct Labour | | | | | | | | | | | |

TABLE 3Q
Example inflation

| | | Europe | | | | | | | | | | | | | |
|---|---|---|---|---|---|---|---|---|---|---|---|---|---|---|---|
| | | Aus- | Ger- | | | | | | | | | | | | |
| | Europe | tria | many | Gibraltar | Greece | Italy | Malta | Netherlands | Norway | Poland | Portugal | Spain | Sweeden | Switzerland | UK |
| 2011 | 0.0% | 0.0% | 0.0% | 0.0% | 0.0% | 0.0% | 0.0% | 0.0% | 0.0% | 0.0% | 0.0% | 0.0% | 0.0% | 0.0% | 0.0% |
| 2012 | 2.0% | 2.0% | 2.0% | 2.0% | 2.0% | 2.0% | 2.0% | 2.0% | 2.0% | 2.0% | 2.0% | 2.0% | 2.0% | 2.0% | 2.0% |
| 2013 | 2.0% | 2.0% | 2.0% | 2.0% | 2.0% | 2.0% | 2.0% | 2.0% | 2.0% | 2.0% | 2.0% | 2.0% | 2.0% | 2.0% | 2.0% |
| 2014 | 2.5% | 2.5% | 2.5% | 2.5% | 2.5% | 2.5% | 2.5% | 2.5% | 2.5% | 2.5% | 2.5% | 2.5% | 2.5% | 2.5% | 2.5% |
| 2015 | 2.7% | 2.7% | 2.7% | 2.7% | 2.7% | 2.7% | 2.7% | 2.7% | 2.7% | 2.7% | 2.7% | 2.7% | 2.7% | 2.7% | 2.7% |
| 2016 | 2.7% | 2.7% | 2.7% | 2.7% | 2.7% | 2.7% | 2.7% | 2.7% | 2.7% | 2.7% | 2.7% | 2.7% | 2.7% | 2.7% | 2.7% |
| 2017 | 3.0% | 3.0% | 3.0% | 3.0% | 3.0% | 3.0% | 3.0% | 3.0% | 3.0% | 3.0% | 3.0% | 3.0% | 3.0% | 3.0% | 3.0% |

Further, assume that inflation is given by Table 3Q. For the Netherlands the inflation in 2014 with respect to 2011 amounts to 2.5%, and for 2015 this amounts to 2.7%. So, the costs in Table 3P of the first three months need to be multiplied with 102.5%, and the costs of the remaining months have to be multiplied with 102.7%.

Step 13: Reporting Currency

The last step before the P50 MOD estimate is finished, is converting all cost from the local currency to the reporting currency. Exchange rate differ over time, therefore, the conversion will be on a monthly base.

Necessary input is equal to the input of step 12.

Input step 13

Sourcing locations
Phasing profile

2) Calculations Step 13

Table 3R gives an example of (future) exchange rate listed per location.

TABLE 3R

| | | | Europe | | | Asia Pacific | |
|---|---|---|---|---|---|---|---|
| | | Eur- | | Neth- | Asia | Malay- | |
| | | ope | Italy | erlands | Pacific | sia | Myanmar |
| Exchange | 2011 | | 0.72 | 0.72 | | 3.02 | . . . |
| Rates | 2012 | | 0.78 | 0.78 | | 3.14 | . . . |
| (step 13) | 2013 | | 0.78 | 0.78 | | 3.14 | . . . |
| | 2014 | | 0.78 | 0.78 | | 3.13 | . . . |
| | 2015 | | 0.77 | 0.77 | | 3.12 | . . . |
| | 2016 | | 0.77 | 0.77 | | 3.12 | . . . |
| | 2017 | | 0.77 | 0.77 | | 3.12 | . . . |
| | 2018 | | 0.77 | 0.77 | | 3.12 | . . . |
| | 2019 | | 0.77 | 0.77 | | 3.12 | . . . |
| | 2020 | | 0.77 | 0.77 | | 3.12 | . . . |

With these exchange rates the cost, in USD, is determined for the example in Table 3S.

TABLE 3S
Example conversion to reporting currency

| CBS | Italy | | | Netherlands | | | Malaysia | | |
|---|---|---|---|---|---|---|---|---|---|
| Group | nov-14 | dec-14 | jan-15 | nov-14 | dec-14 | jan-15 | nov-14 | dec-14 | jan-15 |
| Col- | [symbol] 4.000 | [symbol] 5.000 | [symbol] 4.000 | [symbol] 5.000 | [symbol] 6.000 | [symbol] 5.000 | MYR 10.000 | MYR 12.000 | MYR 10.000 |
| umns | USD 5.128 | USD 6.410 | USD 5.195 | USD 6.410 | USD 7.692 | USD 6.494 | USD 3.195 | USD 3.834 | USD 3.205 |

Step 14: P50 Estimate

In step 14 of the CCET method and system according to the invention all costs for components, other materials and labor estimated in accordance with steps 1-13 and illustrated in FIGS. 5 and 6 are summed to come to a final cost estimate for construction the hydrocarbon fluid processing facility preferably with a P50 associated financial uncertainty, which implies that there is about 50% chance that the actual cost, in money of the day, for constructing the facility will comply with the presented cost estimate and that there is about 50% chance that the actual cost, in money of the day, for constructing the facility will deviate from the presented cost estimate.

1. A method for estimating the cost of constructing a hydrocarbon fluid production and/or processing facility with various components, including pumps, vessels, pipelines, support and foundation structures and power, control, safety and other equipment, and other materials, which components and other materials are manufactured or purchased at different locations and are subsequently transported to and assembled at a construction site of the facility, the method comprising:
providing an engineering and procurement database, which database induces a user to identify aggregate quantities of components, other materials and associated transportation, installation and other labor, required to construct the facility and which database further comprises financial data regarding the components, other materials and labor, which financial data include the estimated cost for manufacturing or purchasing, transporting and installing the components and other materials in a specified currency and in money of the day, with provisions for associated financial uncertainty, including inflation, allowances, market factors, taxes and contingencies; and
providing a dashboard that presents to the user:
a) a cost estimate for constructing the hydrocarbon fluid processing facility based on the financial data derived from the engineering and procurement database; and
b) the associated financial uncertainty as a chance that the actual cost, in money of the day, for constructing the facility will deviate from the presented cost estimate.

2. The method of claim 1, wherein the dashboard has a default setting that presents the financial uncertainty of the cost estimate such that there are substantially equal chances that the actual cost will exceed or stay below the cost estimate.

3. The method of claim 2, wherein the dashboard allows the user to modify the financial uncertainty by varying the chance that the actual cost will deviate from the cost estimate.

4. The method of claim 1, wherein the database is configured to calculate the aggregate cost of the components, materials and labor required to construct the facility in accordance with the following 14 steps:
1) estimate aggregate quantities of the components and equipment of the facility and of materials, construction equipment and labor required to construct the facility;
2) update each aggregate quantity using a quantity allowance for each of the aggregate quantities;
3) further update each aggregate quantity by providing a loss factor for each of the aggregate quantities;
4) estimate sourcing cost for each aggregate quantity, which sourcing cost estimate includes application of a sourcing profile and a productivity factor that depends on geographic location of the facility;
5) update the sourcing cost estimate using a location factor that depends on the geographic location of the facility;
6) further update the sourcing cost estimate updated in accordance with step 5 for each of the aggregate quantities using a sourcing cost allowance factor that depends on the geographic location of the facility;
7) further update the sourcing cost estimate updated in accordance with step 6 by estimating cost for transportation, tax and duties of each of components, materials and labor;
8) further update the sourcing cost estimate updated in accordance with step 7 using an estimated cost phasing factor associated with the moment on which the cost are expected to be made;
9) further update the sourcing cost estimate updated in accordance with step using an estimated a market factor associated with the geographic location of the facility;
10) further update the sourcing cost estimate updated in accordance with step using an estimated Engineering, Procurement & Construction (EPC) premium factor;
11) further update the sourcing cost estimate updated in accordance with step 10 a using an estimated contingency factor;
12) further update the sourcing cost estimate updated in accordance with step 11 using an inflation correction factor that is associated with the moment on which the cost are expected to be made;
13) further update the sourcing cost estimate updated in accordance with step 12 by accumulating the sourcing cost estimates for all components, other materials and labor cost and expressing the accumulated sourcing cost estimate in a reporting currency; and
14) inducing the dashboard to present to the user the accumulated sourcing cost estimate as the cost estimate for constructing the facility updated in accordance with step together with the associated financial uncertainty.

5. The method of claim 4, wherein the associated financial uncertainty is expressed as chance that the actual cost for constructing the plant will deviate from the cost estimate, which chance is adjustable from 1% to 99%, and is in a default setting of the dashboard set at about 50%.

6. The method of claim 1, wherein the hydrocarbon fluid production and/or processing facility is an onshore or offshore crude oil and/or natural gas production facility comprising a number of crude oil and/or natural gas production wells and transportation pipelines, which are optionally lined pipes.

7. The method of claim 1, wherein the hydrocarbon fluid production and/or processing facility is an oil refinery or a natural gas processing facility.

8. The method of claim 7, wherein the natural gas processing facility is a Gas To Liquids (GTL) production plant in which natural gas is converted into marketable liquid products or a Liquefied Natural Gas (LNG) processing facility.

9. The method of claim 1, wherein the hydrocarbon fluid processing facility is a chemical plant in which hydrocarbon fluids are converted into marketable chemical products.

10. The method of claim 1, wherein the hydrocarbon fluid processing facility comprises a series of standard scalable components of which the designs and cost estimates are stored in the database.

11. The method of claim 10, wherein the engineering and procurement database comprises a scope tree with a Work Breakdown Schedule (WBS) that groups the hydrocarbon fluid processing facility into the groups of onshore, offshore and deepwater hydrocarbon fluid processing facilities and associated wells, pipelines and terminals and which groups the components into hardware items, system groups, equipment accessories, derived items and further comprises a user interface which allows a user to generate a design of the hydrocarbon fluid processing facility by selecting in the database components which the user identifies to be suitable for a given flux, composition, pressure and/or other physical characteristics of the hydrocarbon fluid to be processed in the facility.

12. The method of claim 10, wherein the standard scalable components comprise pumps, vessels, pipelines, columns, columns, support structures and power supply, safety and control systems.

13. The method of claim 1, wherein the hydrocarbon fluid processing facility is constructed if the cost estimate does not exceed a selected limit.

14. A system for performing the method according to claim 1, wherein the system comprises a computer readable medium, which when connected to a computer, causes the computer to execute the method.

15. The system of claim 14, wherein the computer readable medium is a data carrier selected from the group of data carriers comprising a CD, a DVD, a computer hard disk, a USB stick and/or any other electronic, magnetic or optical data carrier.
